(19) United States
(12) Patent Application Publication
(10) Pub. No.: US 2001/0021953 A1
(43) Pub. Date: Sep. 13, 2001

(54) Data processing circuit

(76) Inventor: Katsuya Nakashima, Nagasaki (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/758,425

(22) Filed: Jan. 12, 2001

(30) Foreign Application Priority Data
Jan. 14, 2000 (JP) P2000-010220

(51) Int. Cl. G06F 3/00

(52) U.S. Cl. 710/5; 713/400

(57) ABSTRACT

A data processing circuit capable of easily reducing an error of timings between data to minimum while suppressing an increase of wiring number and cross-talk effects by setting any value as a delay value to a register from a CPU as an external apparatus, being configured to be able to adjust a delay time of a delay circuit based on the delay value set from outside and to suitably adjust an input timing of input data and an output timing of output data.

### BACKGROUND OF THE INVENTION

1. Field of the Invention

The present invention relates to a data processing circuit, such as a semiconductor apparatus, for example simultaneously handling multiple-bit data and controlling an input timing and output timing of the respective data in synchronization with a clock signal from outside.

2. Description of the Related Art

In a semiconductor product which simultaneously handles multiple-bit data and controls an input timing and output timing of the respective data in synchronization with an external clock signal, as shown in FIG. 1, a clock signal to be a reference of a timing for data is often mutually supplied when transferring data to and from an external semiconductor product. This technique is generally called source synchronous.

In recent years, there has been a crucial matter to attain a faster data transfer speed between semiconductor elements as a result of an improvement of an operation frequency of semiconductor elements (particularly, a CPU).

To cope with the matters, in a semiconductor apparatus including a data processing circuit using the above mentioned source synchronous technique, for example a method explained below is applied.

Namely, in the method, when outputting data from one semiconductor element, a timing that the other semiconductor element retrieves the data is output together with the output data so that the other semiconductor element retrieves the data at a more accurate timing.

By using this technique, it became possible to improve the data transfer rate and to transfer data even if a term wherein data is definite is short.

A further specific explanation will be made with reference to FIGS. 1 and 2.

Note that, in FIG. 1, it is assumed that there are n number of data input/output terminals between a semiconductor element A and a semiconductor element B. Generally, there are some cases where one semiconductor element B is connected to a plurality of semiconductor element A, but it is not essential, so a case of one to one connection will be explained here.

Here, in FIG. 1, a case of transferring data from the semiconductor element A to the semiconductor element B will be explained.

Also, FIGS. 2A and 2B are timing charts of viewing data output from the semiconductor element A at a position of the semiconductor element B.

Waveforms of the data are, as shown in FIGS. 2A and 2B, divided to a term (definite term) Tdef where all data is output correctly and a term (indefinite term) Tindef where some data is not output correctly.

Note that in FIGS. 2A and 2B, t1 and t2 indicate timings when the semiconductor element B takes in the data, t3 indicates a timing when the data changes fastest, and t4 indicates a timing when the data changes slowest.

A clock signal φB output as a timing when the data is taken in from the semiconductor element A to the semiconductor element B normally changes at a timing of the center of the definite period Tdef and informs the semiconductor element B that it is optimal to take in the data at the timings t1 and t2.

As a result that the clock signal φB changes at the center of the Tdef, a margin for a case where a timing of the data signal is inverted due to some reasons can be made maximum.

By using this technique, it became possible to improve the data transfer rate and to transfer the data even if the term when the data is definite is short.

Summarizing the problem to be solved by the invention, even if this technique is used, however, a term when the data is indefinite exists. The indefinite term of data is caused by the reasons below.

The first cause is that a timing of data output from the semiconductor element A differs in every data, that is, skew.

Specifically, when there are a terminal from which data is output earlier and a terminal from which data is output late, it is indefinite as a whole as long as the all data is definite.

The second cause is that deviation of delay time of a signal line on a wiring board on which a signal is sent from the semiconductor element A to the semiconductor element B.

The definite term of data has to be longer than the sum of a set up time in data retrieving by the semiconductor element B and a specification value of a holding time.

The set up time and the holding time are different for respective data terminals and thus have skew in that meaning.

Hitherto, an inner layout of a semiconductor element has been devised and a package has been devised for decreasing skews in the semiconductor element A and the semiconductor element B.

It is however very difficult to eliminate skew by varying transistor characteristics in a semiconductor element and difference of a power source voltage in the semiconductor element.

Particularly, in a data transfer of multiple bits and at a high speed over 1 GHz, deviation of the timing between data, that is, the skew becomes a crucial matter.

In a data transfer at a high speed, a period of correct data naturally becomes short in one cycle.

At this time, when there is deviation in timing between data, although some data can be transferred correctly, others cannot be transferred correctly in some cases.

This is because wrong data is retrieved in a different semiconductor element in the case of data mistaken at a data retrieving timing.

When data transfer speed is sufficiently slow, the skew did not become a disadvantage because the size was sufficiently large with respect to data cycle time, however, when performing data transfer at a speed over 1 GHz as in the recent years, the skewing comes to be a large element to disturb the data transfer at a high speed.

FIG. 3 is a view of a layout of data lines on a wiring board.

In FIG. 3, only two data lines are shown wherein the DL1 indicates a data line with a long straight line length and the DL2 indicates a data line with a short straight line length. The T indicates a terminal.

An effort is made on a delay time of a signal line on the wiring board by applying equal length wiring so that the delay time does not deviate. But as shown in FIG. 3, it is necessary to wire to have folded parts so that the delay time of the data line DL2 having a short straight line becomes the same length as the delay time of the data line DL1 having a long straight line.

An increase of the data width in the recent years caused harmful side-effects that a wiring layer had to be increased, a distance between different wiring became close and a problem of cross-talk was arisen, etc. due to such wiring.

### SUMMARY OF THE INVENTION

An object of the present invention is to provide a data processing circuit capable of easily reducing deviation of timing between data to minimum while suppressing an increase of the number of wiring and cross-talk effects.

According to a first aspect of the present invention, there is provided a data processing circuit, comprising at least one data input terminal; at least one data input circuit provided corresponding to the data input terminal, having a delay value use holding means capable of setting a delay value to a value from outside, and a delay circuit for delaying data input to the data input terminal based on the delay value held in the delay value use holding means.

Also, the data processing circuit according to a first aspect comprises an input use holding means provided on either an input side of the data input terminal and a delay circuit or an output side of the delay circuit, for holding input data to the data input terminal or output data of the delay circuit in synchronization with a predetermined input use clock and outputting the same.

Preferably, the delay value from outside is input from the data input terminal.

According to a second aspect of the present invention, there is provided a data processing circuit using an external clock as a reference for a data input timing, comprising: at least one data input terminal; an input use clock generation circuit for generating an input use clock based on the external clock; and at least one data input circuit provided corresponding to the data input terminal, having a delay value use holding means capable of setting a delay value to a value from outside, a delay circuit for delaying input data based on the delay value held in the delay value use holding means, and an input use holding means provided on either an input side of the data input terminal and a delay circuit or an output side of the delay circuit, for holding input data to the data input terminal or output data of the delay circuit in synchronization with an input use clock generated by the input use clock generation circuit and outputting the same.

According to a third aspect of the present invention, there is provided a data processing circuit using an external clock as a reference for a data input timing, comprising: at least one data input terminal; an input use clock generation circuit for generating an input use clock based on the external clock; and at least one data input circuit provided corresponding to the data input terminal, having an adjustment value use holding means capable of setting an adjustment value to a value from outside, an adjustment circuit for adjusting a phase of the input use clock generated by the input use clock generation circuit based on the adjustment value held in the adjustment value use holding means, and an input use holding means for holding input data to the data input terminal in synchronization with the input use clock wherein the phase is adjusted by the adjustment circuit and outputting the same.

According to a fourth aspect of the present invention, there is provided a data processing circuit using an external clock as a reference for a data input timing, comprising: at least one data input terminal; an input use clock generation circuit for generating an input use clock based on the external clock; and at least one data input circuit provided corresponding to the data input terminal, having a adjustment value use holding means capable of setting an adjustment value to a value from outside, a delay circuit for delaying input data based on the adjustment value held in the adjustment value use holding means, an adjustment circuit for adjusting a phase of the input use clock generated by the input use clock generation circuit based on the adjustment value held in the adjustment value use holding means, and an input use holding means provided on either an input side of the data input terminal and a delay circuit or an output side of the delay circuit, for holding input data to the data input terminal or output data of the delay circuit in synchronization with an input use clock wherein the phase is adjusted by the adjustment circuit and outputting the same.

Preferably, the delay circuit use adjustment value and the adjustment circuit use adjustment value are different.

According to a fifth aspect of the present invention, there is provided a data processing circuit, comprising: at least one output terminal; at least one data output circuit provided corresponding to the data output terminal, having a delay value use holding means capable of setting a delay value to a value from outside, and a delay circuit for delaying data to be output to the data output terminal based on the delay value held in the delay value use holding means.

Preferably, the data processing circuit further comprises an output use holding means provided on either an output side of the data output terminal and a delay circuit or an input side of the delay circuit, for holding output data of the delay circuit or input data to the delay circuit in synchronization with a predetermined output use clock and outputting the same.

According to a sixth aspect of the present invention, there is provided a data processing circuit using an external clock as a reference for a data output timing, comprising: at least one data output terminal; an output use clock generation circuit for generating an output use clock based on the external clock; and at least one data output circuit provided corresponding to the data output terminal, having a delay value use holding means capable of setting a delay value to a value from outside, a delay circuit for delaying data to be output based on the delay value held in the delay value use holding means, and an output use holding means provided on either an output side of the data output terminal and a delay circuit or an input side of the delay circuit, for holding output data of the delay circuit or input data to the delay circuit in synchronization with an output use clock generated by the output use clock generation circuit and outputting the same.

According to a seventh aspect of the present invention, there is provided a data processing circuit using an external clock as a reference for a data output timing, comprising: at least one data output terminal; an output use clock generation circuit for generating an output use clock based on the external clock; and at least one data output circuit provided corresponding to the data output terminal, having an adjustment value use holding means capable of setting an adjustment value to a value from outside, an adjustment circuit for adjusting a phase of the output use clock generated by the output use clock generation circuit based on the adjustment value held in the adjustment value use holding means, and an output use holding means provided on either an output side of the data output terminal and a delay circuit or an input side of the delay circuit, for holding output data of the delay circuit or input data to the delay circuit in synchronization with an output use clock wherein the phase is adjusted by the adjustment circuit and outputting the same.

According to a eighth aspect of the present invention, there is provided a data processing circuit using an external clock as a reference for a data output timing, comprising: at least one data output terminal; an output use clock generation circuit for generating an output use clock based on the external clock; and at least one data output circuit provided corresponding to the data output terminal, having an adjustment value use holding means capable of setting an adjustment value to a value from outside, a delay circuit for delaying data to be output based on the adjustment value held in the adjustment value use holding means, an adjustment circuit for adjusting a phase of the output use clock generated by the output use clock generation circuit based on the adjustment value held in the adjustment value use holding means, and an output use holding means provided on either an output side of the data output terminal and a delay circuit or an input side of the delay circuit, for holding output data of the delay circuit or an input data to the delay circuit in synchronization with an output use clock wherein the phase is adjusted by the adjustment circuit and outputting the same.

According to a ninth aspect of the present invention, there is provided a data processing circuit comprising at least one data input/output terminal; at least one data input/output circuit provided corresponding to the data input/output terminal, having a delay value use holding means capable of setting a delay value to a value from outside, a first delay circuit for delaying data input to the data input/output terminal based on the delay value held in the delay value use holding means, and a second delay circuit for delaying data to be output to the data input/output terminal based on the delay value held in the delay value use holding means.

Preferably, the data processing circuit further comprises an input use holding means provided on either an input side of the data input/output terminal and first delay circuit or an output side of the first delay circuit, for holding input data to the data input/output terminal or output data of the first delay circuit in synchronization with a predetermined input use clock and outputting the same; and an output use holding means provided on either an output side of the data input/output terminal and second delay circuit or an input side of the second delay circuit, for holding output data of the second delay circuit or input data to the second delay circuit in synchronization with a predetermined output use clock.

Preferably, the delay value from outside is input from the data input/output terminal.

According to a tenth aspect of the present invention, there is provided a data processing circuit using an external clock as a reference for data input and output timings, comprising: at least one data input/output terminal; an input use clock generation circuit for generating an input use clock based on the external clock; an output use clock generation circuit for generating an output use clock based on the external clock; and at least one data output circuit provided corresponding to the data input/output terminal, having a delay value use holding means capable of setting a delay value to a value from outside, a first delay circuit for delaying input data based on the delay value held in the delay value use holding means, an input use holding means provided on either an input side of the data input/output terminal and first delay circuit or an output side of the first delay circuit, for holding input data to the data input/output terminal or an output data of the first delay circuit in synchronization with an input use clock generated by the input use clock generation circuit, a second delay circuit for delaying data to be output based on the delay value held in the delay value use holding means, and an output use holding means provided on either an output side of the data input/output terminal and second delay circuit or an input side of the second delay circuit, for holding output data of the second delay circuit or input data to the second delay circuit in synchronization with the output use clock generated in the output use clock generation circuit and outputting the same.

According to a eleventh aspect of the present invention, there is provided a data processing circuit using an external clock as a reference for data input and output timings, comprising: at least one data input/output terminal; an input use clock generation circuit for generating an input use clock based on the external clock; an output use clock generation circuit for generating an output use clock based on the external clock; and at least one data input/output circuit provided corresponding to the data input/output terminal, having an adjustment value use holding means capable of setting an adjustment value to a value from outside, a first adjustment for adjusting a phase of the input use clock generated by the input use clock generation circuit based on an adjustment value held in the adjustment value use holding means, an input use holding means for holding input data to the data input/output terminal in synchronization with the input use clock wherein the phase is adjusted by the first adjustment circuit and outputting the same, a second adjustment circuit for adjusting a phase of the output use clock generated by the output use clock generation circuit based on the adjustment value held by the adjustment value use holding means, and an output use holding means provided on either an output side of the data input/output terminal and second delay circuit or an input side of the second delay circuit, for holding output data of the second delay circuit or input data to the second delay circuit in synchronization with the output clock wherein the phase is adjusted by the second adjustment circuit and outputting the same.

According to a twelfth aspect of the present invention, there is provided a data processing circuit using an external clock as a reference for data input and output timings, comprising: at least one data input/output terminal; an input use clock generation circuit for generating an input use clock based on the external clock; an output use clock generation circuit for generating an output use clock based on the external clock; and at least one data input/output circuit provided corresponding to the data input/output terminal, having an adjustment value use holding means capable of setting an adjustment value to a value from outside, a first delay circuit for delaying input data based on the adjustment value held in the adjustment value use holding means, a first adjustment circuit for adjusting a phase of the input use clock generated by the input use clock generation circuit based on an adjustment value held in the adjustment value use holding means, an input use holding means provided on either an input side of the data input/output terminal and first delay circuit or an output side of the first delay circuit, for holding input data to the data input/output terminal or output data of the first delay circuit in synchronization with the input use clock wherein the phase is adjusted by the first adjustment circuit and outputting the same, a second delay circuit for delaying data to be output based on the adjustment value held in the adjustment value use holding means, a second adjustment circuit for adjusting a phase of the output use clock generated by the output use clock generation circuit based on the adjustment value held in the adjustment value use holding means, and an output use holding means provided on either an output side of the data input/output terminal and second delay circuit or an input side of the second delay circuit, for holding output data of the second delay circuit or input data to the second delay circuit in synchronization with the output clock wherein the phase is adjusted by the second adjustment circuit and outputting the same.

Also, in the present invention, there is provided a data processing circuit comprising: an external apparatus for setting the adjustment value of the adjustment value holding means to a value, confirming whether or not it operates at the set adjustment value, and selecting and setting an optimal delay value at an initial state.

Also, in the present invention, the delay circuit or adjustment circuit is capable of adjusting a delay time by receiving the delay compensation signal.

According to the present invention, a delay value or adjustment value set to be any value is set to the delay value or adjustment value use holding means from outside.

A delay time of a delay circuit or an adjustment circuit or a phase of input use or output use clock are adjusted to be earlier or late based on the delay value or adjustment value set from outside and an input timing of input data and output timing of output data are suitably adjusted.

As explained above, by changing a value to be input to the holding means from outside, timings of an input and output can be adjusted from outside and deviation (skew) of timings of the respective input/output data can be minimized.

Further, by repeating sending of a signal to adjust a delay time automatically from an external semiconductor product and judging of whether it operates at the timing when for example the semiconductor product is started up (powered up), an optimal timing can be obtained and an operation at the optimal timing can be realized regardless of characteristics differences of products.

Further, in the compensation circuit, a phase difference between a reference signal passed through a wiring on an external wiring board to be a reference of a delay time and a reference signal passed through a delay circuit is fed-back as a delay compensation signal to the delay circuit. As a result, it becomes possible to output a delay compensation signal by which a delay time by the delay circuit and a delay time in the external wiring becomes equal.

### BRIEF DESCRIPTION OF THE DRAWINGS

These and other objects and features of the present invention will become clearer from the following description of the preferred embodiments given with reference to the accompanying drawings, in which:

FIG. 1 is a view for explaining data transfer between general semiconductor elements;

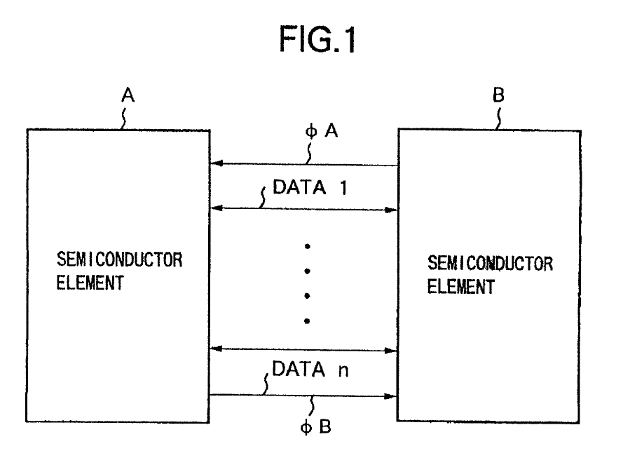

FIGS. 2A and 2B are timing charts of data output from a semiconductor element A when viewing at a position of a semiconductor element B;

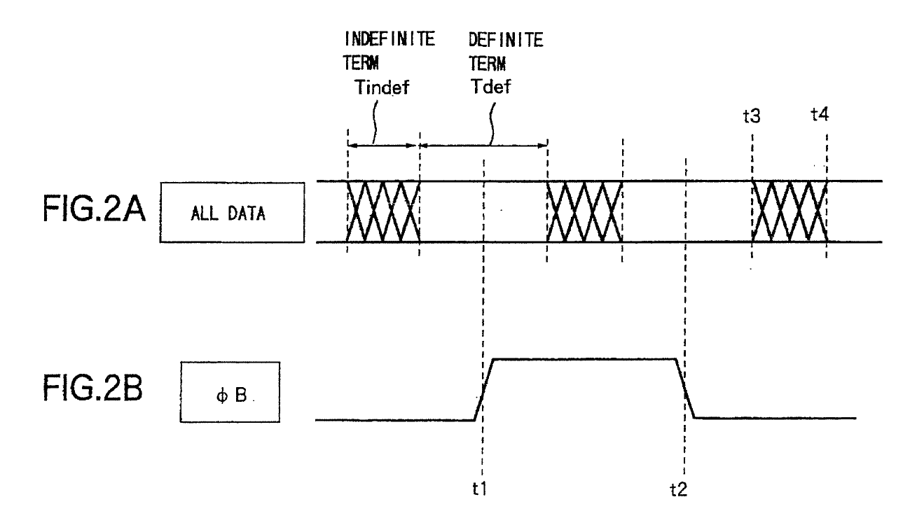

FIG. 3 is a view of an example of a layout of data wiring on a wiring board;

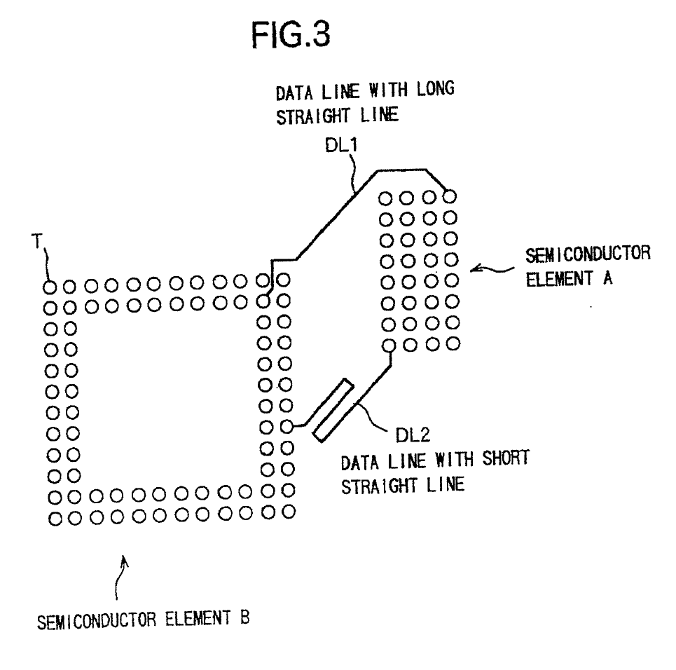

FIG. 4 is a circuit diagram of a first embodiment of a semiconductor apparatus as a data processing circuit according to the present invention;

FIG. 5 is a circuit diagram of an example of a specific configuration of a variable delay circuit according to the present invention;

FIGS. 6A to 6C are views of relationship of timing information of input data from outside and delay times of two input use variable delay circuits of FIG. 4;

FIG. 7 is a circuit diagram of a second embodiment of a semiconductor apparatus as a data processing circuit according to the present invention;

FIG. 8 is a circuit diagram of a third embodiment of a semiconductor apparatus as a data processing circuit according to the present invention;

FIG. 9 is a block diagram of an example of a specific configuration of a DLL circuit of FIG. 8;

FIGS. 10A to 10C are timing charts of a DLL circuit of FIG. 9; and

FIG. 11 is a view for explaining a fourth embodiment of a semiconductor apparatus as a data processing circuit according to the present invention.

### DESCRIPTION OF THE PREFERRED EMBODIMENTS

Below, preferred embodiments will be described with reference to the accompanying drawings.

First Embodiment

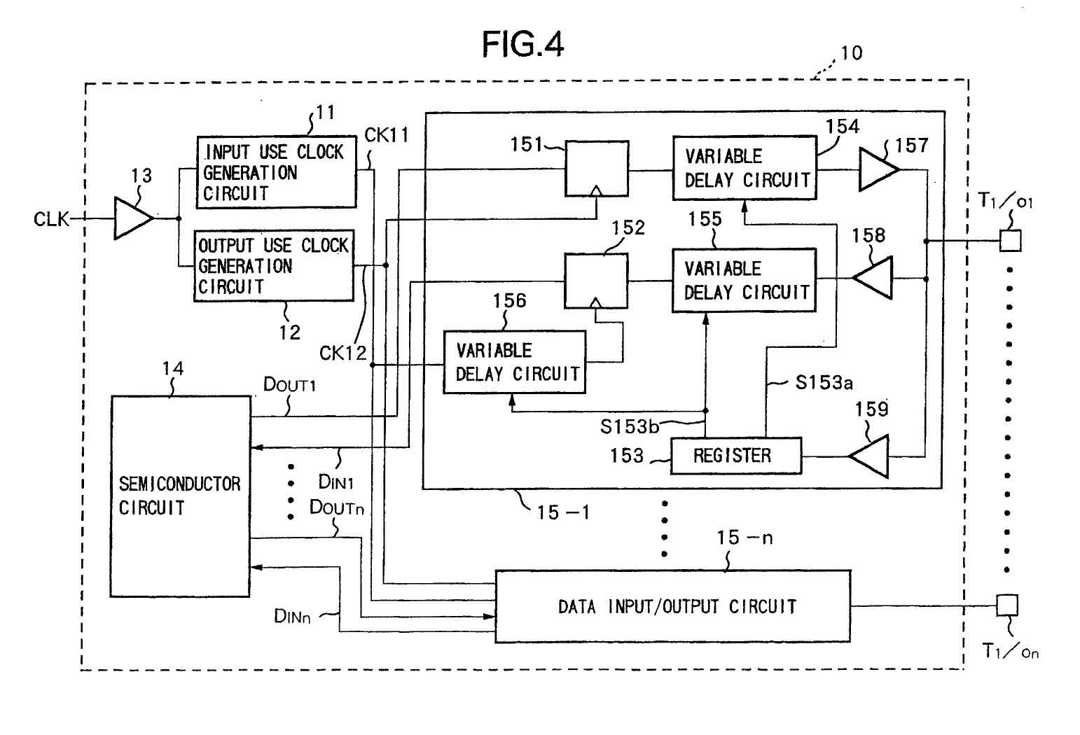

FIG. 4 is a circuit diagram of a first embodiment of a semiconductor apparatus as a data processing circuit according to the present invention.

A semiconductor apparatus 10 according to the present first embodiment comprises, as shown in FIG. 4, an input use clock generation circuit 11, an output use clock generation circuit 12, a clock use buffer 13, a semiconductor circuit 14, data input/output circuits 15-1 to 15-n (note that n is a positive integer), and data input/output terminals TI/O1 to TI/On as main components.

Note that only a circuit affixed the reference number 15-1 is shown the specific configuration in the data input/output circuit in FIG. 4 for a simpler drawing. The configuration of other data input/output circuits 15-2 to 15-n is the same as that of the data input/output circuit 15-1, so the specific configuration is omitted.

The input use clock generation circuit 11 receives a clock signal CLK from the outside via the buffer 13, generates a data input timing use clock signal CK11 of the data input/output circuits 15-1 to 15-n and supplies to the data input/output circuits 15-1 to 15-n.

The input clock generation circuit 12 receives a clock signal CLK from the outside via the buffer 13, generates a data output timing use clock signal CK12 of the data input/output circuits 15-1 to 15-n and supplies to the data input/output circuits 15-1 to 15-n.

The semiconductor circuit 14 comprises a semiconductor memory apparatus, for example such as a static random access memory (SRAM), stores input data DIN1 to DINn input to the data input/output circuits 15-1 to 15-n and supplies the stored data to be read based on an address designation to the respective data input/output circuits 15-1 to 15-n as output data DOUT1 to DOUTn.

The data input/output circuit 15-1 gives a delay to the input data DIN1 to the semiconductor circuit 14 or the output data DOUT1 to the outside by a delay time based on a delay value which can be set from the outside, minimizes a deviation (skew) of a timing of the input/output data, and inputs and outputs the data.

The data input/output circuit 15-1 comprises, as shown in FIG. 4, an output use register 151, an input use register 152, a delay value use register 153, variable delay circuits 154, 155 and 156, an output buffer 157 and input buffers 158 and 159.

The output use register 151 holds the output data DOUT1 read from the semiconductor circuit 14 as the SRAM in synchronization with the output use clock CK12 generated by the output use clock generation circuit 12, and supplies the same to the variable delay circuit 152.

The input register 152 holds the input data DIN1 to be stored in the semiconductor circuit 14 being delayed in the variable delay circuit 155 in synchronization with the input use clock CLK11 from the input use clock generation circuit 11 being delayed by a predetermined time in the variable delay circuit 156, and supplies the same to the semiconductor circuit 14.

The delay value use register 153 holds a timing adjustment use information which is input to the data input/output terminal TI/O1 from for example a not illustrated CPU as an external apparatus, and input via the input buffer 159 and supplies the held information to the variable delay circuits 154, 155 and 156.

The timing adjustment use information is given as a plurality of bits, for example, 5 bits, and the information is supplied to the respective variable delay circuits 154 to 156 as delay times of the respective variable delay circuits 154, 155 and 156.

When it is a 5-bit information, adjustment of the second [fifth] power, namely 32 kinds can be performed on the delay time.

The variable delay circuit 154 delays the output data DOUT1 held in the output use register 151 by a delay time based on the timing adjustment use delay value held in the delay value use register 153 and outputs the same from the data input/output terminal TI/O1 via the output buffer 157 to the outside.

Also, the variable delay circuit 154 comprises a not illustrated compensation use input so that the delay time of the delay circuit is not affected by temperature changes or power source voltage changes of the SRAM in addition to an input of data or a clock and an input for controlling the delay time from the outside.

The variable delay circuit 155 delays input data input from the outside to the data input/output terminal TI/O1 via the input buffer 158 by a delay time based on a timing adjustment use delay value held in the delay value use register 153 and outputs the same to the input use register 152.

Also, the variable delay circuit 155 comprises, in the same way as in the variable delay circuit 154, a not illustrated compensation use input so that the delay time of the delay circuit is not affected by temperature changes of the SRAM and power source voltage changes in addition to the input for data and a clock and an input for controlling the delay time from the outside.

The variable delay circuit 156 as an adjustment circuit delays the input use clock CLKl1 from the input use clock generation circuit 11 by a delay time based on the timing adjustment use delay value held in the delay value use register 153 and supplies to the input use register 152.

Also, the variable delay circuit 156 comprises, in the same way as in the variable delay circuits 154 and 155, a not illustrated compensation use input so that the delay time of the delay circuit is not affected by temperature changes of the SRAM and power source voltage changes in addition to the input for data and a clock and an input for controlling the delay time from the outside.

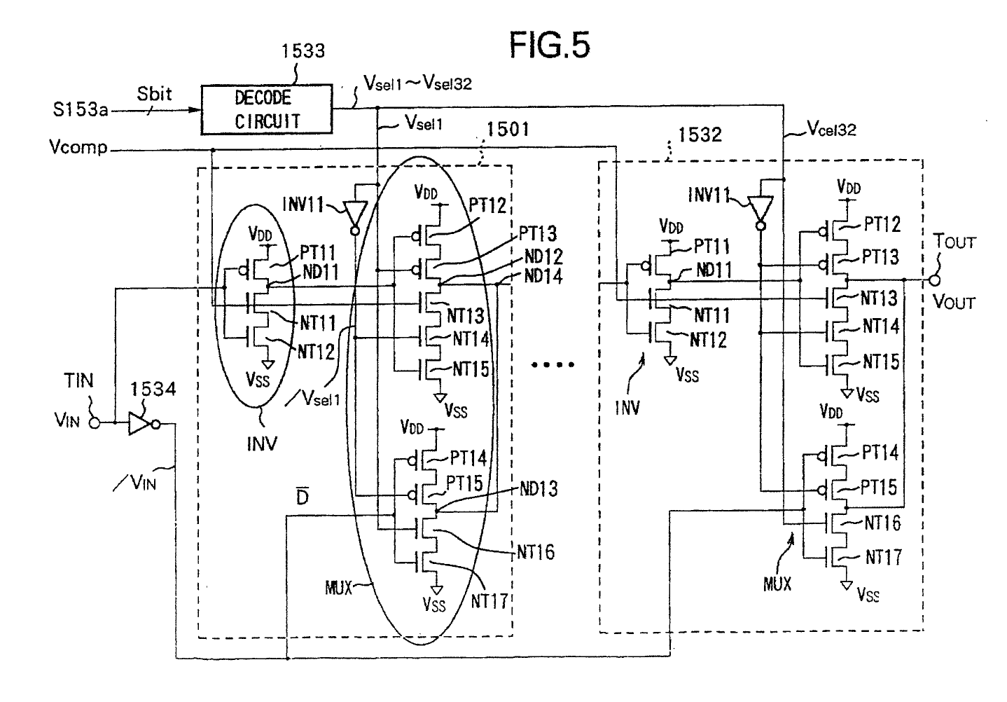

FIG. 5 is a circuit diagram of an example of a specific configuration of the variable delay circuit 154 (155 and 156).

In FIG. 5, a case where the delay value use information is 5 bits and 32 kinds is shown as an example.

Note that it is needless to say but the configuration of the variable delay circuit is not limited to that in FIG. 5.

The variable delay circuit 154 comprises, as shown in FIG. 5, 32 unit delay circuits 1501 to 1532, a decode circuit 1533, and an inverter 1534.

The 32 unit delay circuit 1501 to 1532 are connected in series between the input terminal TIN and the output terminal TOUT, inputs data VIN input to the input terminal TIN or output data the unit delay circuit of a former stage or input data via the inverter 1534 in accordance with a decode signal Vsel from the decode circuit 1533 and outputs to a circuit in the following stage.

Also, the unit delay circuits 1501 to 1532 are configured to be supplied a delay compensation signal Vcomp having an analog voltage level adjusted from the outside so that the delay time can be adjustable for every unit delay circuit.

The unit delay circuit 1501 (to 1532) comprises an inverter portion INV and a multiplexer portion MUX.

The inverter portion INV comprises a p-channel MOS (PMOS) transistor PT11 and n-channel MOS (NMOS) transistors NT11 and NT12.

A source of the PMOS transistor PT11 is connected to a supply line of a power source voltage VDD, a drain is connected to a drain of the NMOS transistor NT11, and its connection node ND11 is connected to an input gate of the multiplexer portion MUX.

A source of the NMOS transistor NT11 is connected to a drain of the NMOS transistor NT12 and a source of the NMOS transistor NT12 is connected to a reference potential Vss (ground potential).

A gate of the PMOS transistor PT11 and a gate of the NMOS transistor NT12 are connected to the input terminal TIN and a gate of the NMOS transistor NT11 is connected to a supply line of the delay compensation signal Vcomp.

On-resistance of the NMOS transistor NT11 is adjusted in accordance with a supply level of the delay compensation signal Vcomp.

Note that a gate of the PMOS transistor PT11 of the inverter portion INV of the unit delay circuits 1502 (not illustrated) to 1532 and a gate of the NMOS transistor NT12 are supplied with output data of the unit delay circuits 1501 to 1531 of the former stage.

The multiplexer portion MUX is comprised of PMOS transistors PT12 to PT15, NMOS transistors NT13 to NT17 and an inverter INV11.

A source of the PMOS transistor PT12 is connected to a supply line of the power source voltage VDD and a drain is connected to a source of the PMOS transistor PT13, a drain of the PMOS transistor PT13 is connected to a drain of the NMOS transistor NT13 and a node ND12 is comprised of a connection point of the drains.

A source of the NMOS transistor NT13 is connected to a drain of the NMOS transistor NT14, a source of the NMOS transistor NT14 is connected to a drain of the NMOS transistor NT15 and a source of the NMOS transistor NT15 is connected to the reference potential Vss (ground potential).

A source of the PMOS transistor PT14 is connected to a supply line of the power source voltage VDD and a drain is connected to a source of the PMOS transistor PT15, a drain of the PMOS transistor PT15 is connected to a drain of the NMOS transistor NT16 and a node ND13 is comprised of a connection point of the drains.

A source of the NMOS transistor NT16 is connected to a drain of the NMOS transistor NT17 and a source of the NMOS transistor NT17 is connected to the reference potential Vss (ground potential).

The node ND12 and the node ND13 are connected and an output node ND14 of the variable delay circuit 1501 is constituted by the connection point.

Output nodes ND14 of the variable delay circuits 1501 to 1531 are connected to inverter portions of the variable delay circuits 1502 to 1532 of the next stage.

Note that the output node ND14 of the variable delay circuit of the last stage is connected to an output terminal TOUT of output data VOUT.

Also, a gate of the PMOS transistor PT12 and a gate of the NMOS transistor NT15 are connected to the output node ND11 of the inverter portion INV and a gate of the PMOS transistor PT13 and a gate of the NMOS transistor NT16 are connected to a supply line of a decode signal Vsell.

Also, a gate of the NMOS transistor NT14 and a gate of the PMOS transistor PT15 are connected to an output terminal of the inverter INV11 and the gates are supplied with an inversed signal /Vsell (“/” indicates an inversion) of the decode signal Vsell.

A gate of the NMOS transistor NT13 is connected to a supply line of the delay compensation signal Vcomp. On-resistance of the NMOS transistor NT13 is adjusted in accordance with a supply level of the delay compensation signal Vcomp.

Furthermore, a gate of the PMOS transistor PT14 and a gate of the NMOS transistor NT17 are connected to an output terminal of the inverter 1534 and the gates are supplied with an inversed signal /VIN of the input data VIN.

Note that the inversed signal /VIN of the input data VIN is suppled in parallel to the 32 unit delay circuits 1501 to 1532.

The unit delay circuits 1501 to 1532 having the above configuration further inverse the input data via the inverter portion INV and output the same from the output node ND14 when receiving decode signals Vsell to Vsel32 of a logic “0”, respectively, while it inverse the inversed signal /VIN from the inverter 1534 and output the same from the output node ND14 when receiving those of a logic “1”.

The decode circuit 1533 decodes a 5-bit delay time control signal S153a set in the delay value use register 153, generates 32 kinds of decode signals Vsel1 to Vsel32 of either a logic of “1” or “0” in accordance with the decoding results, and outputs to the corresponding unit delay circuits 1501 to 1532.

Specifically, only one of the decode signals Vsel1 to Vsel32 is set to a logic “1” and the remaining signals are set to a logic of “0”.

For example, when timing adjustment use information indicated by the delay time control signal S153a is “0”, only the decode signal Vsel32 to the unit delay circuit 1532 which is the closest to the output terminal TOUT is set to a logic of “1” and other decode signals Vsel1 to Vsel31 are set to be “0” and are supplied to the corresponding unit delay circuits 1501 to 1531.

In this case, in the unit delay circuit 1532 of the last stage, an inversed signal /VIN of the input data VIN is inversed and output as output data VOUT to the output terminal.

Accordingly the delay time becomes the minimum in this case.

When the timing adjustment use information indicated by the delay time control signal S153a is “1”, only the decode signal Vsel31 to the unit delay circuit 1531 is set to a logic of “1”, while other decode signals Vsel1 to Vsel30 and Vsel32 are set to a logic of “0” to be supplied to the corresponding unit delay circuits 1501 to 1530 and 1532.

In this case, in the unit delay circuit 1531, an inversed signal /VIN of the input data VIN is inversed, output from the output node ND14 to the unit delay circuit 1532 of the last stage, and a signal delayed by one stage amount via the inverter portion INV and the multiplexer portion MUX of the unit delay circuit 1532 is output as output data VOUT to the output terminal TOUT.

Similarly, when the timing adjustment use information indicated by the delay time control signal S153 is “31”, only the decode signal Vsel1 which is the most distant from the output terminal TOUT is set to have a logic of “1”, while other decode signals Vsel12 to Vsel32 are set to a logic of “0”, and supplied to the corresponding unit delay circuits 1502 to 1532.

In this case, in the unit delay circuit 1501, the inversed signal /VIN of the input data VIN is inversed, and a signal delayed by an amount of 31 stages is output as the output data VOUT from the output node ND14 to the unit delay circuit 1502 of the next stage and output as the output data VOUT from the output node ND14 of the unit delay circuit 1532 of the last stage to the output terminal TOUT.

Accordingly, the delay time becomes the maximum in this case, as well.

By suitably adjusting a value of the timing adjustment use information as mentioned above, the delay time can be gradually changed.

Also, delay times of the unit delay circuits 1501 to 1532 can be separately adjusted by the delay compensation signal Vcomp which is an analog signal.

This adjustment is carried out when a temperature or a power source voltage of the SRAM changes and when the change has to be canceled out (compensated).

Note that when a delay circuit is used as in the present embodiment, a timing of data output cannot be adjusted to be earlier.

In this case, it is possible to make a timing of data output look relatively earlier by delaying a clock by designating a timing clock CLK (φB) for a not illustrated CPU to retrieve the output data.

Here, since the clock φB does not always exists in every data terminal, the clock φB is made suitably delayed to make a condition where the output timing is relatively fast, and an optimal output timing is searched by gradually delaying the output timing of the respective data when the delay time of the respective data terminals are at minimum.

Also, the data input system circuit in the present first embodiment, the variable delay circuits 155 and 156 are inserted between the input buffer 158 and the input use register 152 and to a supply line of the input use register 152 of the input use clock CK11.

When the semiconductor circuit (SRAM) delays in retrieving input data with respect to the clock CLK (φA) from the outside, a delay time of the variable delay circuit 155 is made short or a delay time of the variable delay circuit 156 is made long.

On the other hand, when retrieving input data for the semiconductor circuit (SRAM) 14 earlier with respect to a clock φA from the outside, a delay time of the variable delay circuit 155 is made long or a delay time of the variable delay circuit 156 is made short.

Since the variable delay circuits 155 and 156 are correspondingly provided for every data, a timing of the input data can be made fast and late separately for every data.

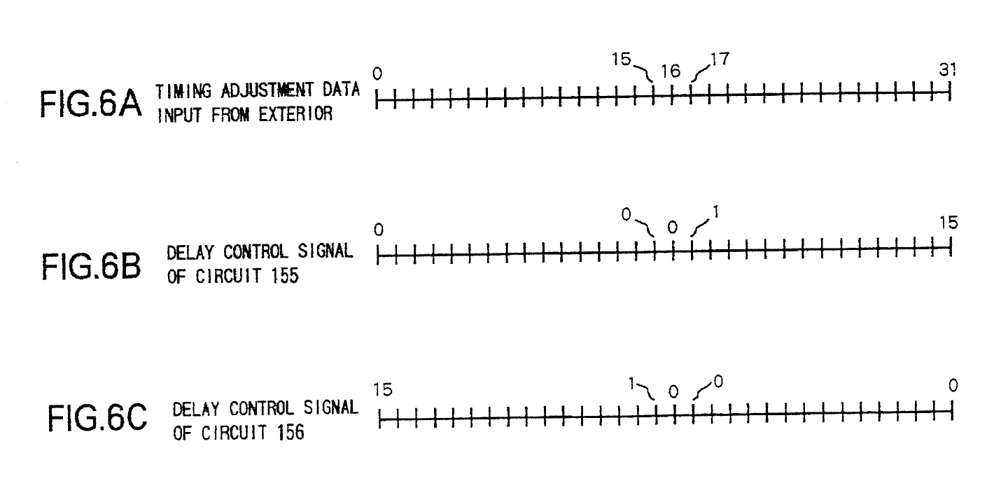

FIGS. 6A to 6C are views of the relationship of timing information of input data from the outside and a delay time of the delay circuits 155 and 156.

Here, as explained above, assuming a case where timing adjustment by 32 stages from the outside is possible.

A timing adjustment signal from the outside has a value between 0 and 31 (5-bit information) which indicates that the larger the value, the earlier the semiconductor circuit 14 (SRAM) retrieves input data with respect to an external clock φA.

The reference timing is when the value is 16 and both of the variable delay circuits 155 and 156 have the minimum delay time.

Next, an operation by the above configuration will be explained.

First, an operation of adjusting the timing when a not illustrated CPU retrieves data read from the semiconductor circuit (SRAM) 14 of the semiconductor apparatus 10 will be explained.

The CPU sends an output timing adjustment use information to the semiconductor apparatus 10. The output timing adjustment use information is sent to the semiconductor apparatus 10 by using the same data line.

The output timing adjustment use information sent from the CPU is for example input from a data input/output terminal TI/01 to a data input/output circuit 15-1 and held in the delay value use register 153 via the input buffer 159.

The timing adjustment use information held in the delay value use register 153 is given for example as the 5-bit information and the information is supplied as a delay time of the variable delay circuits 154, 155 and 156 to the variable delay circuits 154 to 156.

In this state, the semiconductor circuit (SRAM) 14 of the semiconductor apparatus 10 is operated from the CPU and whether it operates normally at the timing is judged.

First, data is written from the CPU to the semiconductor circuit 14. In this case, an input use clock CK11 is generated in the input use clock generation circuit 11 based on an external clock CLK and supplied to the variable delay circuit 156 in the semiconductor apparatus 10.

In the variable delay circuit 156, the input use clock CK11 is delayed by a delay time based on a timing adjustment use delay value held in the delay value use register 153 and supplied to the input use register 152.

Also, the write data sent from the CPU to the semiconductor apparatus 10 is input to the data input/output terminal TI/01 and input to the data input/output circuit 15-1. The write data input to the data input/output circuit 15-1 is input to the variable delay circuit 155 via the input buffer 158.

In the variable delay circuit 155, the data is delayed by a delay time based on the timing adjustment use delay value held in the delay value use register 153 and output to the input use register 152.

Then in the input use register 152, the write data is held in synchronization with a delay input use clock supplied from the variable delay circuit 156 and supplied to the semiconductor circuit (SRAM) 14.

As a result, the input data is written into a predetermined address of the semiconductor circuit 14.

Next, the data is read from the semiconductor circuit 14. In this case, an output use clock CK12 is generated in an output use clock generation circuit 11 based on the external clock and supplied to the output use register 151 in the semiconductor apparatus 10.

In the output register 151, the data read from a predetermined address in the semiconductor circuit (SRAM) 14 is held in synchronization with the output use clock CK12 and supplied to the variable delay circuit 154.

In the variable delay circuit 154, the data is delayed by a delay time based on the timing adjustment use delay value held in the delay value use register 153 and output data is sent from the data input/output terminal TI/01 to the CPU via the output buffer 157.

Note that since the semiconductor circuit (SRAM) 14 cannot always surely retrieve data due to timings, a plurality of cycles are used for surely writing to the SRAM.

The CPU holds data written in the semiconductor circuit (SRAM) 14 and judges whether the data read from the SRAM matches the written data.

The CPU stores whether the data was correctly read from the SRAM at the timing.

Next, the above data writing and data reading operation and the matching operation of the write data and read data are repeated by changing the output timing adjustment use information.

Note that the reading cannot be performed correctly when the timing is longer or shorter than what required. In the above procedure, an optimal timing for the data terminal can be found by using an exactly middle value in a timing range where the reading was correctly performed.

The above operation is performed on all data input/output terminals TI/01 to TI/0n.

Since the CPU is capable of judging data separately for the respective data terminals, it is possible to find an optimal timing for each of the data terminal in parallel.

Further, generally, since a variety of reset cycles operates when the CPU starts up (powers up), it is possible to find an optimal timing by using this term. Also, by searching an optimal timing at the time of starting up the CPU, an optimal timing can be set regardless of difference in characteristics of the CPU and semiconductor apparatus 10.

Next, an operation of adjusting a timing when the semiconductor circuit (SRAM) 14 of the semiconductor apparatus 10 retrieves data from the CPU will be explained. In this case, a timing of retrieving input data in the semiconductor apparatus 10 will be adjusted.

This operation is performed in almost the same way as the above operation.

Namely, the CPU sends an output timing judgement use information to the semiconductor apparatus 10. The output timing adjustment use information is sent to the semiconductor apparatus 10 by using the same data line.

The output timing adjustment use information sent from the CPU is for example input from the data input/output terminal TI/01 to the data input/output circuit 15-1 and held in the delay value use register 153 via the input buffer 159.

The timing adjustment use information held in the delay value use register 153 is given for example as the 5-bit information and the information is supplied as a delay time of the variable delay circuits 154, 155, and 156 to the variable delay circuits 154 to 156.

In this state, the semiconductor circuit (SRAM) 14 of the semiconductor apparatus 10 is operated from the CPU and whether it operates normally at the timing is judged.

First, data is written from the CPU to the semiconductor circuit 14. In this case, an input use clock CK11 is generated in the input use clock generation circuit 11 based on an external clock CLK and supplied to the variable delay circuit 156 in the semiconductor apparatus 10.

In the variable delay circuit 156, the input clock CK11 is delayed by a delay time based on the timing adjustment use delay value held in the delay value use register 153 and supplied to the input use register 152.

Also, the write data sent from the CPU to the semiconductor apparatus 10 is input to the data input/output terminal TI/01 and input to the data input/output circuit 15-1. The write data input to the data input/output circuit 15-1 is input to the variable delay circuit 155 via the input buffer 158.

In the variable delay circuit 155, the data is delayed by a delay time based on the timing adjustment use delay value held in the delay value use register 153 and output to the input use register 152.

In the input use register 152, the write data is held in synchronization with a delay input use clock supplied from the variable delay circuit 156 and supplied to the semiconductor circuit (SRAM) 14.

As a result, the input data is written into a predetermined address of the semiconductor circuit 14.

Next, data is read from the semiconductor circuit 14. In this case, an output use clock CK12 is generated in the output clock generation circuit 11 and supplied to the output register 151 in the semiconductor apparatus 10.

In the output register 151, the data read from a predetermined address of the semiconductor circuit (SRAM) 14 is held in synchronization with the output use clock CK12 and supplied to the variable delay circuit 154.

In the variable delay circuit 154, the data is delayed by a delay time based on the timing adjustment delay value held in the delay value use register 153 and the output data is sent from the data input/output terminal TI/01 to the CPU via the output buffer 157.

Then, the CPU judges whether the semiconductor circuit (SRAM) 14 of the semiconductor apparatus 10 correctly reads the data from the CPU.

At this time, reading data from the semiconductor circuit (SRAM) 14 is not always surely performed at a correct timing, but it is sufficient if one data is taken out by using a plurality of cycles from the SRAM and a sufficient allowance is given to the reading timing from the SRAM. The CPU stores whether the semiconductor apparatus 10 side was able to retrieve the data correctly at the timing.

Next, the above data writing and data reading operation and matching operation of the write data and the read data are repeated by changing the data retrieving timing.

Note that the retrieving cannot be correctly performed when the data retrieving timing is earlier or later than what required. In the above procedure, an optimal timing for the data terminal can be obtained by using an exactly middle value in the timing range where the reading was correctly performed.

The above operation is performed on every data input/output terminals TI/01 to TI/0n.

As explained above, according to the present first embodiment, since a delay value from the CPU as an external apparatus is voluntarily set in the register 153, it is configured to be able to adjust delay times of the delay circuits 154, 155 and 156 based on the delay value set from the outside, and it is configured to suitably adjust an input timing of the input data and output timing of the output data, there is an advantage that deviation of timing between data, which becomes the largest disadvantage at the time of performing a multiple-bit data transfer at a high speed over 1 GHz, can be easily made minimum.

Further, by making it possible to easily adjust the deviation of the timing from the outside, it is possible to adjust the timing during a power up time of a semiconductor element, accordingly, it becomes possible to use at an optimal timing without being affected by dispersion between respective products.

Second Embodiment

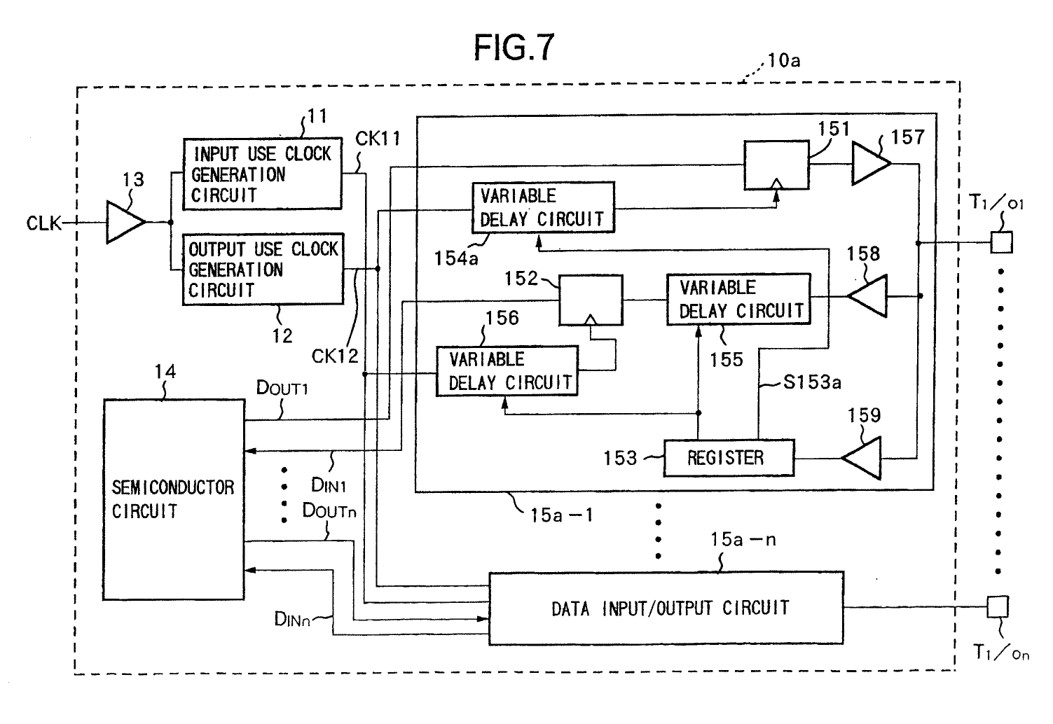

FIG. 7 is a circuit diagram of a second embodiment of a semiconductor apparatus as a data processing circuit according to the present invention.

A different point of the present embodiment from the above first embodiment is that the output use clock CK12 to the output use register 151 is delayed by the variable delay circuit 154 to adjust a timing of holding of the sealing data by the semiconductor circuit 14 instead of delaying output data itself by arranging the data output variable delay circuit 154 between the output use register 151 and the output use buffer 157 in the data input/output circuit.

Other configurations and operations are the same as those in the first embodiment.

According to the second embodiment, the same effects as in the above first embodiment can be obtained.

Third Embodiment

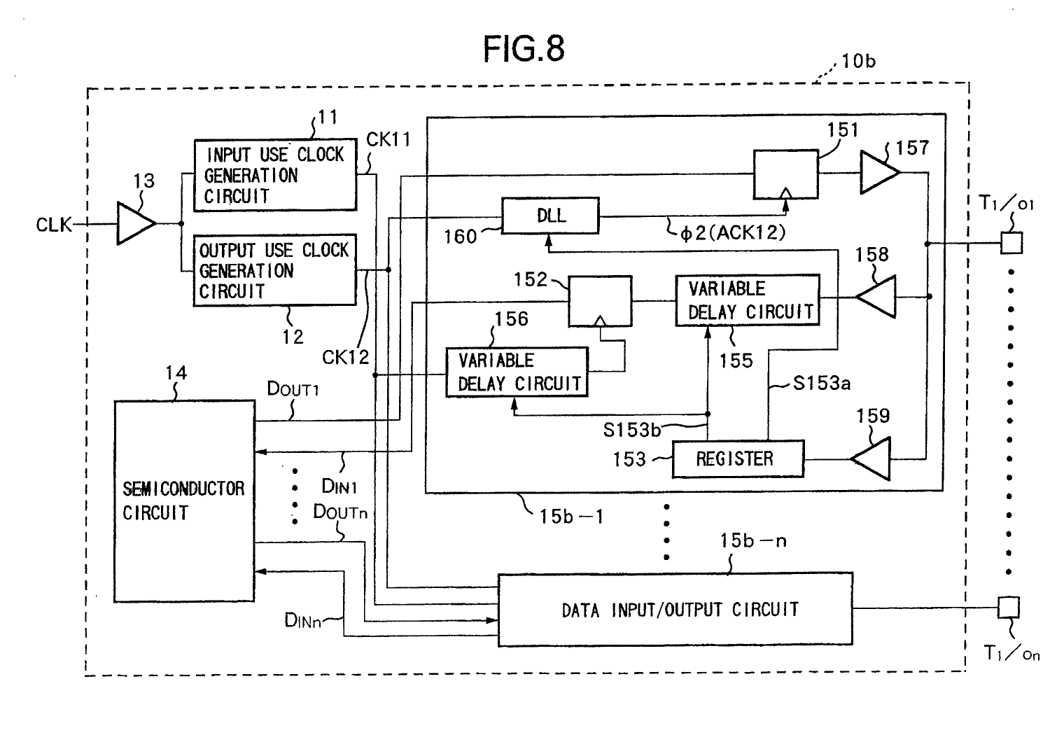

FIG. 8 is a circuit diagram of a third embodiment of a semiconductor apparatus as a data processing circuit according to the present invention.

A different point of the present third embodiment from the above second embodiment is that the timing for retrieving data to the output use register 151 is adjusted by a delay locked loop (DLL) circuit 160 as an adjustment circuit for adjusting a phase of the output use clock instead of adjusting an output timing of data by delaying to the output use clock by the variable delay circuit in the data output system of the data input/output circuit.

The reason of using the DLL circuit 160 instead of the delay circuit is as explained below.

Namely, as in the second embodiment, when using a delay circuit capable of adjusting, a timing for outputting data cannot be made earlier separately for each data in a data output system circuit.

Furthermore, due to have the delay circuit, an accessing time from a clock input of the semiconductor apparatus to a data output becomes late.

Thus, the DLL circuit is used, by which a timing of supplying a clock to the output use register 151 can be freely made early or later.

Namely, in a semiconductor apparatus 10b according to the present third embodiment, the timing of a clock ACK12 of the output use register 151 can be adjusted by using the DLL circuit 160.

Accordingly, the timing of the clock ACK12 can be freely made early or later. Also, the timing of the clock ACK12 is not always later than that of the output use clock CK12, so the accessing time does not become late.

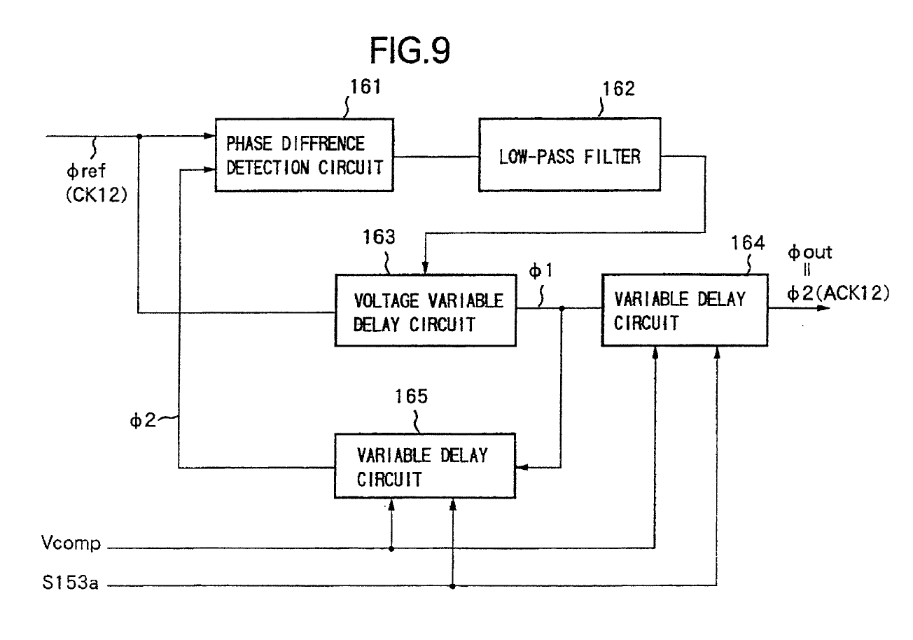

FIG. 9 is a block diagram of an example of a specific configuration of the DLL circuit of FIG. 8.

As shown in FIG. 9, the DLL circuit 160 comprises a phase difference detection circuit 161, a low-pass filter 162, a voltage variable delay circuit 163 and variable delay circuits 164 and 165.

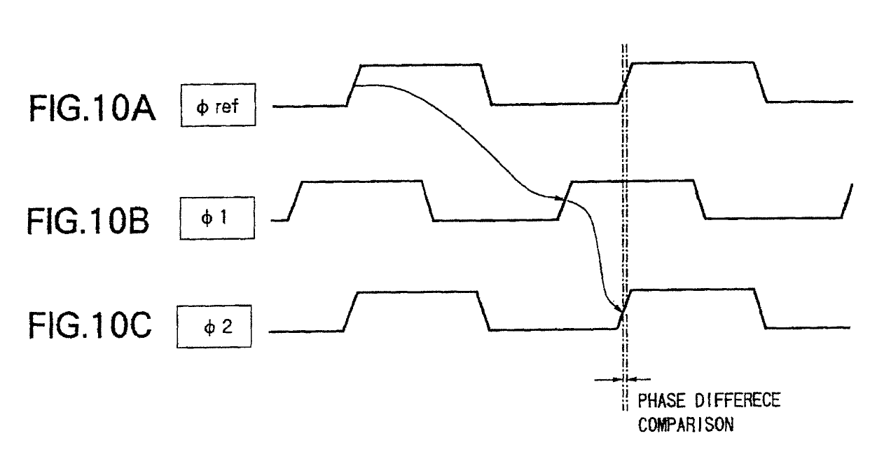

The configuration and function of the DLL circuit 160 will be explained with reference to FIG. 9 and timing charts of FIGS. 10A to 10C.

In FIG. 9, φref is an input clock of the DLL circuit 160, that is, an output use clock CK12 generated in the output use clock generation circuit 12 and a clock to be a reference of the DLL circuit 160.

The reference clock φref is input to the phase difference detection circuit 161 and a voltage variable delay circuit 163.

In the phase difference detection circuit 161, the phase comparison between the reference clock φref and the output clock φ2 of the variable delay circuit 165 is performed and the result is supplied as a signal S161 to the low-pass filter 162.

In the low-pass filter 162, an analog control voltage Vc is generated based on the signal S161 and supplied to the voltage variable delay circuit 163.

The voltage variable delay circuit 163 is configured as a delay circuit capable of adjusting a delay time from the input reference clock φref to an output φ1 by the analog voltage Vc.

The output clock of the voltage variable delay circuit 163 wherein a delay time is adjusted in accordance with the analog voltage Vc is supplied to the variable delay circuits 164 and 165.

The variable delay circuits 164 and 165 are programmable delay circuits and able to be adjusted from the outside. The adjusting value is, as explained above, given as a signal S153a based on the timing adjustment use information set in the delay value use register 153.

Note that the variable delay circuits 164 and 165 comprises an input for a delay compensation signal Vcomp for preventing the delay time of the delay circuit from being affected by changes of a temperature and power source voltage of the SRAM in addition to an input for data or a clock and an input for controlling a delay time from the outside.

The output φ2 of the variable delay circuit 165 is basically, as shown in FIGS. 10A to 10C, the reference clock φref being delayed the phase by 2π.

By detecting the phase difference between the reference clock φref and the output φ2 by the phase difference detection circuit 161 and feeding-back to the voltage variable delay circuit 163 via the low-pass filter 162, it becomes possible to operate so that the reference clock φref and the output φ2 are completely matched.

An output φout of the DLL circuit 160 is generated by delaying the output φ1 of the voltage variable delay circuit 163 by the variable delay circuit 164.

At this time, if delay times of the variable delay circuit 164 and the variable delay circuit 165 are completely the same, the timing of the output φout can be made same as that of the reference clock φref by an operation of the DLL.

Also, the variable delay circuits 164 and 165 are configured for example as a circuit shown in FIG. 5. Note that it is needless to say that the circuit can be configured by configurations other than that.

When it is desired to make the output φout earlier than the reference clock φref, it is sufficient to set the delay time of the variable delay circuit 165 longer.

Also, when it is desired to make the output φout later than the reference clock φref, it is sufficient to set the delay time of the variable delay circuit 164 longer.

According to the third embodiment, in addition to the effects by the above first and second embodiments, there are advantages that in the data output system circuit, a timing for outputting data can be separately made earlier for every data and it becomes possible to be used at an optimal timing without being affected by dispersions of respective products.

Note that the DLL circuit can be applied as a circuit for adjusting a phase of the input use clock.

Fourth Embodiment

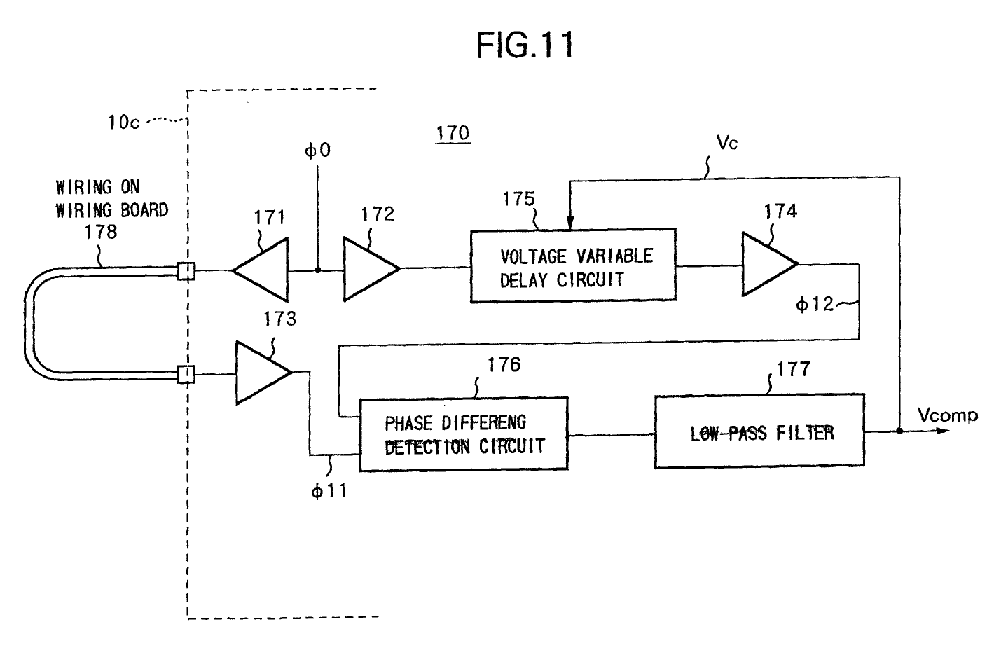

FIG. 11 is a view for explaining a fourth embodiment of a semiconductor apparatus as a data processing circuit according to the present invention.

The present fourth embodiment relates to a compensation circuit 170 for preventing a delay time from being affected by changes of temperature and power source voltage of the semiconductor apparatus 10c.

Other portions of the semiconductor apparatus 10c may be configured in the same way as the configuration in FIGS. 4, 7 or 8.

The compensation circuit 170 comprises, as shown in FIG. 11, buffers 171 to 174, a voltage variable delay circuit 175, a phase difference detection circuit 176, a low-pass filter 177, and an external wiring 178 on the wiring board.

In FIG. 11, a clock φ0 is a clock to be a reference for operating the compensation circuit 170 and generated by an input clock of the semiconductor apparatus 10c.

Further, the buffers 171 and 172 are same in characteristics while the buffers 173 and 174 are same in characteristics, as well.

The clock φ0 is input to the wiring 178 and the voltage variable delay circuit 175, respectively via the buffers 171 and 172.

The clock propagated the external wiring 178 is input to the phase difference detection circuit 176 via the buffer 173 and the input clock to the voltage variable delay circuit 175 is input to the same via the buffer 174.

In the phase difference detection circuit 176, phases are compared between the clock φ11 passed through the external wiring 178 and buffer 173 and the clock φ12 passed through the voltage variable delay circuit 175 and buffer 174, and the result is fed-back to the voltage variable delay circuit 175 via the low-pass filter 177.

As a result, the timing of the clocks φ11 and φ12, that is, the delay time of the external wiring 178 and that of the internal voltage variable delay circuit 175 are adjusted to be same.

Since the delay time of the external wiring 178 is constant regardless of a temperature, power source voltage, etc. of the semiconductor apparatus 10c, the delay time of the voltage variable delay circuit 175 is also able to be automatically adjusted not to depend on the temperature, power source voltage, etc.

If the voltage variable delay circuit 175 is equivalent with a programmable delay circuit provided for every data input/output terminal (I/O), namely, if it is designed to generate same delay times for same analog voltage, the output of the low-pass filter 177 becomes a signal for compensating a delay time of the programmable delay circuit of every data input/output circuit.

Note that the analog voltage Vc by the low-pass filter 177 is supplied as a delay compensation signal Vcomp to a variable delay circuit or a DLL circuit arranged on a not illustrated data input/output circuit.

Actually, since an output of the low-pass filter is an analog signal, it is safe against noise to convert to a digital signal to be supplied to the respective data input/output circuits and convert again to an analog signal therein.

According to the fourth embodiment, in addition to the configurations of the above first, second and third embodiments, by connecting the wiring 178 to be a reference of the delay time on the external wiring board of the semiconductor apparatus and regarding the delay time of the wiring as a reference, there is an advantage that a circuit wherein the delay time does not change even if a temperature or power source voltage of the semiconductor apparatus changes can be realized.

Further, by adjusting a timing between data in the semiconductor apparatus, it becomes unnecessary to even up the delays between wiring on the wiring board.

As a result, there are advantages that the wiring pattern can be made simple, the number of wiring layers can be reduced due to wiring in a narrow area, and a wiring pattern little affected by cross-talk can be realized.

While the invention has been described with reference to specific embodiment chosen for purpose of illustration, it should be apparent that numerous modifications could be made thereto by those skilled in the art without departing from the basic concept and scope of the invention.

What is claimed is:

1. A data processing circuit, comprising:
at least one data input terminal;
at least one data input circuit provided corresponding to said data input terminal, having a delay value use holding means capable of setting a delay value to a value from outside, and a delay circuit for delaying data input to said data input terminal based on the delay value held in said delay value use holding means.

2. A data processing circuit as set forth in claim 1, further comprising:
an input use holding means provided on either an input side of said data input terminal and a delay circuit or an output side of said delay circuit, for holding input data to said data input terminal or output data of said delay circuit in synchronization with a predetermined input use clock and outputting the same.

3. A data processing circuit as set forth in claim 1, wherein said delay value from outside is input from said data input terminal.

4. A data processing circuit as set forth in claim 1, further comprising:
an external apparatus for setting said delay value of said delay value use holding means to a value, confirming whether or not it operates at a delay time based on the set delay value, and selecting and setting an optimal delay value at an initial state.

5. A data processing circuit as set forth in claim 1, wherein said delay circuit is capable of adjusting a delay time by receiving delay compensation signal.

6. A data processing circuit as set forth in claim 5, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.

7. A data processing circuit using an external clock as a reference for a data input timing, comprising:
at least one data input terminal;
an input use clock generation circuit for generating an input use clock based on said external clock; and
at least one data input circuit provided corresponding to said data input terminal, having
a delay value use holding means capable of setting a delay value to a value from outside,
a delay circuit for delaying input data based on the delay value held in said delay value use holding means, and
an input use holding means provided on either an input side of said data input terminal and a delay circuit or an output side of said delay circuit, for holding input data to said data input terminal or output data of said delay circuit in synchronization with an input use clock generated by said input use clock generation circuit and outputting the same.

8. A data processing circuit as set forth in claim 7, wherein said delay value from the outside is input from said data input terminal.

9. A data processing circuit as set forth in claim 7, further comprising:
an external apparatus for setting said delay value of said delay value use holding means to a value, confirming whether or not it operates at a delay time based on the set delay value, and selecting and setting an optimal delay value at an initial state.

10. A data processing circuit as set forth in claim 7, wherein said delay circuit is capable of adjusting a delay time by receiving the delay compensation signal.

11. A data processing circuit as set forth in claim 10, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.

12. A data processing circuit using an external clock as a reference for a data input timing, comprising:
at least one data input terminal;
an input use clock generation circuit for generating an input use clock based on said external clock; and
at least one data input circuit provided corresponding to said data input terminal, having
an adjustment value use holding means capable of setting an adjustment value to a value from outside,
an adjustment circuit for adjusting a phase of the input use clock generated by said input use clock generation circuit based on the adjustment value held in said adjustment value use holding means, and
an input use holding means for holding input data to said data input terminal in synchronization with the input use clock wherein the phase is adjusted by said adjustment circuit and outputting the same.

13. A data processing circuit as set forth in claim 12, wherein said adjustment value from the outside is input from said data input terminal.

14. A data processing circuit as set forth in claim 12, further comprising
an external apparatus for setting said adjustment value of said adjustment value use holding means to a value, confirming whether or not it operates at the set adjustment value, and selecting and setting an optimal adjustment value at an initial state.

15. A data processing circuit as set forth in claim 12, wherein said adjustment circuit is capable of adjusting a delay time by receiving the delay compensation signal.

16. A data processing circuit as set forth in claim 15, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.

17. A data processing circuit using an external clock as a reference for a data input timing, comprising:
at least one data input terminal;
an input use clock generation circuit for generating an input use clock based on said external clock; and
at least one data input circuit provided corresponding to said data input terminal, having
a adjustment value use holding means capable of setting an adjustment value to a value from outside,
a delay circuit for delaying input data based on the adjustment value held in said adjustment value use holding means,
an adjustment circuit for adjusting a phase of the input use clock generated by said input use clock generation circuit based on the adjustment value held in said adjustment value use holding means, and
an input use holding means provided on either an input side of said data input terminal and a delay circuit or an output side of said delay circuit, for holding input data to said data input terminal or output data of said delay circuit in synchronization with an input use clock wherein the phase is adjusted by said adjustment circuit and outputting the same.

18. A data processing circuit as set forth in claim 17, wherein said delay circuit use adjustment value and said adjustment circuit use adjustment value are different.

19. A data processing circuit as set forth in claim 17, wherein said adjustment value from the outside is input from said data input terminal.

20. A data processing circuit as set forth in claim 17, further comprising
an external apparatus for setting said adjustment value of said adjustment value use holding means to a value, confirming whether or not it operates at the set adjustment value, and selecting and setting an optimal delay value at an initial state.

21. A data processing circuit as set forth in claim 17, wherein said adjustment circuit is capable of adjusting a delay time by receiving the delay compensation signal.

22. A data processing circuit as set forth in claim 21, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.

23. A data processing circuit, comprising:
at least one output terminal;
at least one data output circuit provided corresponding to said data output terminal, having a delay value use holding means capable of setting a delay value to a value from outside, and a delay circuit for delaying data to be output to said data output terminal based on the delay value held in said delay value use holding means.

24. A data processing circuit as set forth in claim 23, further comprising:
an output use holding means provided on either an output side of said data output terminal and a delay circuit or an input side of said delay circuit, for holding output data of said delay circuit or input data to said delay circuit in synchronization with a predetermined output use clock and outputting the same.

25. A data processing circuit as set forth in claim 23, further comprising:
an external apparatus for setting said delay value of said delay value use holding means to a value, confirming whether or not it operates at a delay time based on the set delay value, and selecting and setting an optimal delay value at an initial state.

26. A data processing circuit as set forth in claim 23, wherein said delay circuit is capable of adjusting a delay time by receiving the delay compensation signal.

27. A data processing circuit as set forth in claim 26, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.

28. A data processing circuit using an external clock as a reference for a data output timing, comprising:
at least one data output terminal;
an output use clock generation circuit for generating an output use clock based on said external clock; and
at least one data output circuit provided corresponding to said data output terminal, having
a delay value use holding means capable of setting a delay value to a value from outside,
a delay circuit for delaying data to be output based on the delay value held in said delay value use holding means, and
an output use holding means provided on either an output side of said data output terminal and a delay circuit or an input side of said delay circuit, for holding output data of said delay circuit or input data to said delay circuit in synchronization with an output use clock generated by said output use clock generation circuit and outputting the same.

29. A data processing circuit as set forth in claim 28, further comprising:
an external apparatus for setting said delay value of said delay value use holding means to a value, confirming whether or not it operates at a delay time based on the set delay value, and selecting and setting an optimal delay value at an initial state.

30. A data processing circuit as set forth in claim 28, wherein said delay circuit is capable of adjusting a delay time by receiving a delay compensation signal.

31. A data processing circuit as set forth in claim 30, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.

32. A data processing circuit using an external clock as a reference for a data output timing, comprising:
at least one data output terminal;
an output use clock generation circuit for generating an output use clock based on said external clock; and
at least one data output circuit provided corresponding to said data output terminal, having
an adjustment value use holding means capable of setting an adjustment value to a value from outside,
an adjustment circuit for adjusting a phase of the output use clock generated by said output use clock generation circuit based on the adjustment value held in said adjustment value use holding means, and
an output use holding means provided on either an output side of said data output terminal and a delay circuit or an input side of said delay circuit, for holding output data of said delay circuit or input data to said delay circuit in synchronization with an output use clock wherein the phase is adjusted by said adjustment circuit and outputting the same.

33. A data processing circuit as set forth in claim 32, further comprising:
an external apparatus for setting said delay value of said delay value use holding means to a value, confirming whether or not it operates at a delay time based on the set delay value, and selecting and setting an optimal delay value at an initial state.

34. A data processing circuit as set forth in claim 32, wherein said delay circuit is capable of adjusting a delay time by receiving the delay compensation signal.

35. A data processing circuit as set forth in claim 34, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.

36. A data processing circuit using an external clock as a reference for a data output timing, comprising:
at least one data output terminal;
an output use clock generation circuit for generating an output use clock based on said external clock; and
at least one data output circuit provided corresponding to said data output terminal, having
an adjustment value use holding means capable of setting an adjustment value to a value from outside,
a delay circuit for delaying data to be output based on the adjustment value held in said adjustment value use holding means,
an adjustment circuit for adjusting a phase of the output use clock generated by said output use clock generation circuit based on the adjustment value held in said adjustment value use holding means, and
an output use holding means provided on either an output side of said data output terminal and a delay circuit or an input side of said delay circuit, for holding output data of said delay circuit or an input data to said delay circuit in synchronization with an output use clock wherein the phase is adjusted by said adjustment circuit and outputting the same.

37. A data processing circuit as set forth in claim 36, wherein said delay circuit use adjustment value and said adjustment circuit use adjustment value are different.

38. A data processing circuit as set forth in claim 36, further comprising:
an external apparatus for setting said adjustment value of said adjustment value use holding means to a value, confirming whether or not it operates at the set adjustment value, and selecting and setting an optimal delay value at an initial state.

39. A data processing circuit as set forth in claim 36, wherein said adjustment circuit is capable of adjusting a delay time by receiving the delay compensation signal.

40. A data processing circuit as set forth in claim 39, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.

41. A data processing circuit, comprising:
at least one data input/output terminal;
at least one data input/output circuit provided corresponding to said data input/output terminal, having
a delay value use holding means capable of setting a delay value to a value from outside,
a first delay circuit for delaying data input to said data input/output terminal based on the delay value held in said delay value use holding means, and
a second delay circuit for delaying data to be output to said data input/output terminal based on the delay value held in said delay value use holding means.

42. A data processing circuit as set forth in claim 41, further comprising:
an input use holding means provided on either an input side of said data input/output terminal and first delay circuit or an output side of said first delay circuit, for holding input data to said data input/output terminal or output data of said first delay circuit in synchronization with a predetermined input use clock and outputting the same; and
an output use holding means provided on either an output side of said data input/output terminal and second delay circuit or an input side of said second delay circuit, for holding output data of said second delay circuit or input data to said second delay circuit in synchronization with a predetermined output use clock.

43. A data processing circuit as set forth in claim 41, wherein said delay value from outside is input from said data input/output terminal.

44. A data processing circuit as set forth in claim 41, further comprising:
an external apparatus for setting said delay value of said delay value use holding means to a value, confirming whether or not it operates at a delay time based on the set delay value, and selecting and setting an optimal delay value at an initial state.

45. A data processing circuit as set forth in claim 41, wherein said delay circuit is capable of adjusting a delay time by receiving a delay compensation signal.

46. A data processing circuit as set forth in claim 45, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.

47. A data processing circuit using an external clock as a reference for data input and output timings, comprising:
at least one data input/output terminal;
an input use clock generation circuit for generating an input use clock based on said external clock;
an output use clock generation circuit for generating an output use clock based on said external clock; and
at least one data output circuit provided corresponding to said data input/output terminal, having
a delay value use holding means capable of setting a delay value to a value from outside,
a first delay circuit for delaying input data based on the delay value held in said delay value use holding means,
an input use holding means provided on either an input side of said data input/output terminal and first delay circuit or an output side of said first delay circuit, for holding input data to said data input/output terminal or an output data of said first delay circuit in synchronization with an input use clock generated by said input use clock generation circuit,
a second delay circuit for delaying data to be output based on the delay value held in said delay value use holding means, and
an output use holding means provided on either an output side of said data input/output terminal and second delay circuit or an input side of said second delay circuit, for holding output data of said second delay circuit or input data to said second delay circuit in synchronization with the output use clock generated in said output use clock generation circuit and outputting the same.

48. A data processing circuit as set forth in claim 47, wherein said delay value from outside is input from said data input/output terminal.

49. A data processing circuit as set forth in claim 47, further comprising:
an external apparatus for setting said delay value of said delay value use holding means to a value, confirming whether or not it operates at a delay time based on the set delay value, and selecting and setting an optimal delay value at an initial state.

50. A data processing circuit as set forth in claim 47, wherein said first and second delay circuits are capable of adjusting a delay time by receiving the delay compensation signal.

51. A data processing circuit as set forth in claim 50, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying to said reference signal by a delay time based on the delay compensation signal; and
a phase comparison means for comparing phases of the reference signal propagated said external wiring and the reference signal delayed by said delay circuit and generating said delay compensation signal in accordance with the comparison result.

52. A data processing circuit using an external clock as a reference for data input and output timings, comprising:
at least one data input/output terminal;
an input use clock generation circuit for generating an input use clock based on said external clock;
an output use clock generation circuit for generating an output use clock based on said external clock; and
at least one data input/output circuit provided corresponding to said data input/output terminal, having
an adjustment value use holding means capable of setting an adjustment value to a value from outside,
a first adjustment for adjusting a phase of the input use clock generated by said input use clock generation circuit based on an adjustment value held in said adjustment value use holding means,
an input use holding means for holding input data to said data input/output terminal in synchronization with the input use clock wherein the phase is adjusted by said first adjustment circuit and outputting the same,
a second adjustment circuit for adjusting a phase of the output use clock generated by said output use clock generation circuit based on the adjustment value held by said adjustment value use holding means, and
an output use holding means provided on either an output side of said data input/output terminal and second delay circuit or an input side of said second delay circuit, for holding output data of said second delay circuit or input data to said second delay circuit in synchronization with the output clock wherein the phase is adjusted by said second adjustment circuit and outputting the same.

53. A data processing circuit as set forth in claim 52, wherein said adjustment value from outside is input from said data input/output terminal.

54. A data processing circuit as set forth in claim 52, further comprising:
an external apparatus for setting said adjustment value of said adjustment value use holding means to a value, confirming whether or not it operates at the set adjustment value, and selecting and setting an optimal delay value at an initial state.

55. A data processing circuit as set forth in claim 52, wherein said adjustment circuit is capable of adjusting a delay time by receiving the delay compensation signal.

56. A data processing circuit as set forth in claim 55, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.

57. A data processing circuit using an external clock as a reference for data input and output timings, comprising:
at least one data input/output terminal;
an input use clock generation circuit for generating an input use clock based on said external clock;
an output use clock generation circuit for generating an output use clock based on said external clock; and
at least one data input/output circuit provided corresponding to said data input/output terminal, having
an adjustment value use holding means capable of setting an adjustment value to a value from outside,
a first delay circuit for delaying input data based on the adjustment value held in said adjustment value use holding means,
a first adjustment circuit for adjusting a phase of the input use clock generated by said input use clock generation circuit based on an adjustment value held in said adjustment value use holding means,
an input use holding means provided on either an input side of said data input/output terminal and first delay circuit or an output side of said first delay circuit, for holding input data to said data input/output terminal or output data of said first delay circuit in synchronization with the input use clock wherein the phase is adjusted by said first adjustment circuit and outputting the same,
a second delay circuit for delaying data to be output based on the adjustment value held in said adjustment value use holding means,
a second adjustment circuit for adjusting a phase of the output use clock generated by said output use clock generation circuit based on the adjustment value held in said adjustment value use holding means, and
an output use holding means provided on either an output side of said data input/output terminal and second delay circuit or an input side of said second delay circuit, for holding output data of said second delay circuit or input data to said second delay circuit in synchronization with the output clock wherein the phase is adjusted by said second adjustment circuit and outputting the same.

58. A data processing circuit as set forth in claim 57, wherein said delay circuit use adjustment value and said adjustment circuit use adjustment value are different.

59. A data processing circuit as set forth in claim 57, wherein said adjustment value from the outside is input from said data input terminal.

60. A data processing circuit as set forth in claim 57, further comprising:
an external apparatus for setting said adjustment value of said adjustment value use holding means to a value, confirming whether or not it operates at the set adjustment value, and selecting and setting an optimal delay value at an initial state.

61. A data processing circuit as set forth in claim 57, wherein said adjustment circuit is capable of adjusting a delay time by receiving the delay compensation signal.

62. A data processing circuit as set forth in claim 61, further comprising:
a compensation circuit having
two signal terminals;
an external wiring connected between said signal terminals to be a reference of a delay time for a reference signal to be propagated;
a delay circuit capable of adjusting a delay time based on a delay compensation signal, for delaying said reference signal by a delay time based on the delay compensation signal; and
a phase comparison means for comparing phases of the reference signal propagated said external wiring and the reference signal delayed by said delay circuit and generating said delay compensation signal in accordance with the comparison result.
